(19) United States
(12) Patent Application Publication
(10) Pub. No.: US 2021/0157326 A1
(43) Pub. Date: May 27, 2021

(54) AUTONOMOUS MOBILE BODY SYSTEM, CONTROL PROGRAM FOR AUTONOMOUS MOBILE BODY, AND CONTROL METHOD FOR AUTONOMOUS MOBILE BODY

(71) Applicant: TOYOTA JIDOSHA KABUSHIKI KAISHA, Toyota-shi (JP)

(72) Inventors: Tomohisa TAKAI, Nagoya-shi (JP); Yuhei YAMAGUCHI, Toyota-shi (JP); Satoshi TOYOSHIMA, Okazaki-shi (JP); Yuta WATANABE, Toyota-shi (JP); Mikio HONDA, Toyota-shi (JP); Shiro ODA, Anjyo-shi (JP); Tetsuya TAIRA, Nagakute-shi (JP); Nobuhisa OTSUKI, Toyota-shi (JP)

(73) Assignee: TOYOTA JIDOSHA KABUSHIKI KAISHA, Toyota-shi (JP)

(21) Appl. No.: 17/097,171

(22) Filed: Nov. 13, 2020

(30) Foreign Application Priority Data
Nov. 25, 2019 (JP) 2019-212556

(51) Int. Cl. G05D 1/02; G05D 1/00; B60Q 1/50; B60Q 5/00

(52) U.S. Cl. CPC G05D 1/0214; G05D 1/0088; B60Q 5/005; B60Q 1/50; G05D 1/0251

(57) ABSTRACT

An autonomous mobile body system including an autonomous mobile body configured to move autonomously, includes a detection unit configured to detect an obstacle around the autonomous mobile body itself, a movement control unit configured to stop a movement of the autonomous mobile body itself when the detection unit detects an obstacle that enters an entry prohibited space set around the autonomous mobile body itself, and an illumination unit configured to illuminate a moving surface so as to indicate an entry prohibited area, the moving surface being a surface on which the autonomous mobile body itself moves, and the entry prohibited area being an area on the moving surface onto which at least a part of the entry prohibited space is projected.

### CROSS REFERENCE TO RELATED APPLICATIONS

This application is based upon and claims the benefit of priority from Japanese patent application No. 2019-212556, filed on Nov. 25, 2019, the disclosure of which is incorporated herein in its entirety by reference.

### BACKGROUND

The present disclosure relates to an autonomous mobile body system, a control program for an autonomous mobile body, and a control method for an autonomous mobile body.

A movable robot equipped with a displaying function for making people around the movable robot itself recognize its moving direction has been known. Such a movable robot is equipped with, for example, a display apparatus in which an LED lamp positioned in a traveling direction lights up, or LED lamps sequentially blink toward a traveling direction (e.g., see Japanese Unexamined Patent Application Publications No. 2011-204145 and No. 2006-219037).

### SUMMARY

In environments where people and autonomous movable bodies typified by movable robots coexist, there have been cases in which even though a person who is present around an autonomous mobile body can recognize the moving direction of that autonomous mobile body, he/she cannot make out how far he/she should be away from the autonomous mobile body, and as a result, he/she unintentionally makes the autonomous movable body suddenly stop.

The present disclosure has been made in order to solve such a problem, and enables a person who is present around an autonomous mobile body to easily make out how far he/she should be away from that autonomous mobile body so that he/she does not interfere with the movement of the autonomous mobile body, and lessens an impact upon contact even when the person does become aware of the presence of the autonomous mobile body.

A first exemplary aspect is an autonomous mobile body system including an autonomous mobile body configured to move autonomously, further including: a detection unit configured to detect an obstacle around the autonomous mobile body itself; a movement control unit configured to stop a movement of the autonomous mobile body itself when the detection unit detects an obstacle that enters an entry prohibited space set around the autonomous mobile body itself; and an illumination unit configured to illuminate a moving surface so as to indicate an entry prohibited area, the moving surface being a surface on which the autonomous mobile body itself moves, and the entry prohibited area being an area on the moving surface onto which at least a part of the entry prohibited space is projected. By configuring the entry prohibited space, which the autonomous mobile body stops when an obstacle enters, so that a person around the autonomous mobile body, which is detected as the obstacle, can recognize the entry prohibited space, the person around the autonomous mobile body can easily make out how far he/she should be away from the autonomous mobile body so that he/she does not interfere with the movement of the autonomous mobile body. Further, even if such a person enters the entry prohibited space, the autonomous mobile body detects the entry of the person and thereby stops its movement, so that an impact upon contact can be lessened.

In the above-described autonomous mobile body system, when the detection unit detects an obstacle that enters an entry restricted space larger than the entry prohibited space, the movement control unit may reduce a moving speed of the autonomous mobile body itself, and the illumination unit may illuminate the moving surface so as to indicate an entry restricted area on the moving surface in addition to or instead of illuminating the entry prohibited area, the entry restricted area being an area on the moving surface onto which at least a part of the entry restricted space is projected. By providing an interference area as described above, it is possible to achieve both the smooth movement of the autonomous mobile body and the safety of people around the autonomous mobile body at the same time.

In particular, the illumination unit may be configured to illuminate the moving surface when the detection unit detects a person who is moving closer to the entry prohibited space. In the case where the detection unit can recognize a person, the illumination unit may illuminate the moving surface only when the detection unit recognizes a person. This feature is desirable in view of the power consumption. Further, the illumination unit may be configured to illuminate the moving surface when the detection unit detects an obstacle that is not indicated in an environmental map that the movement control unit refers to. There are cases where a person moves together with an object in the environment. Therefore, it is possible to make a person recognize the entry prohibited space or the entry restricted space more reliably by starting the illumination as soon as possible upon the detection of an object that is not indicated in the environment map. Further, even in the case where the detection unit is not configured to be able to recognize a person while distinguishing it from an object, the illumination unit may illuminate the moving surface based on a presumption that an obstacle that is not indicated in the environmental map is a person.

Further, the illumination unit may change an illumination pattern projected on the moving surface according to a situation in which the detection unit detects an obstacle. For example, it is possible to reduce power consumption by limiting an illumination area to a direction in which an obstacle is detected. Further, the above-described autonomous mobile body system may include a warning unit configured to produce a warning sound when the detection unit detects that a person has entered an area illuminated by the illumination unit. By the above-described configuration, a person who is moving closer to the autonomous mobile body can avoid contact with the autonomous mobile body by the warning sound even when the person does not perceive the illumination on the moving surface.

Another exemplary aspect is a control program for an autonomous mobile body configured to move autonomously, for causing a computer to perform: a detection step of detecting an obstacle around the autonomous mobile body; a movement control step of stopping a movement of the autonomous mobile body when an obstacle that enters an entry prohibited space set around the autonomous mobile body is detected in the detection step; and an illumination step of illuminating, when at least an obstacle is detected in the detection step, a moving surface so as to indicate an entry prohibited area, the moving surface being a surface on which the autonomous mobile body moves, and the entry prohibited area being an area on the moving surface onto which at least a part of the entry prohibited space is projected. According to the autonomous mobile body controlled by the above-described control program, a person around the autonomous mobile body can easily make out how far he/she should be away from the autonomous mobile body so that he/she does not interfere with the movement of the autonomous mobile body. Further, even if such a person enters the entry prohibited space, the autonomous mobile body detects the entry of the person and thereby stops its movement, so that an impact upon contact can be lessened.

Another exemplary aspect is a method for controlling an autonomous mobile body configured to move autonomously, including: a detection step of detecting an obstacle around the autonomous mobile body; a movement control step of stopping a movement of the autonomous mobile body when an obstacle that enters an entry prohibited space set around the autonomous mobile body is detected in the detection step; and an illumination step of illuminating, when at least an obstacle is detected in the detection step, a moving surface so as to indicate an entry prohibited area, the moving surface being a surface on which the autonomous mobile body moves, and the entry prohibited area being an area on the moving surface onto which at least a part of the entry prohibited space is projected. According to the autonomous mobile body controlled by the above-described control method, a person around the autonomous mobile body can easily make out how far he/she should be away from the autonomous mobile body so that he/she does not interfere with the movement of the autonomous mobile body. Further, even if such a person enters the entry prohibited space, the autonomous mobile body detects the entry of the person and thereby stops its movement, so that an impact upon contact can be lessened.

According to the present disclosure, it is possible to enable a person who is present around an autonomous mobile body to easily make out how far he/she should be away from that autonomous mobile body so that he/she does not interfere with the movement of the autonomous mobile body, and lessen an impact upon contact even when the person does become aware of the presence of the autonomous mobile body.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 shows a state where a transfer robot according to an embodiment moves in an environment in which people coexist with the transfer robot;

FIG. 2 is a perspective view of an external appearance of the transfer robot in a state where the transfer robot illuminates an entry prohibited area;

FIG. 3 is a block diagram showing control of the transfer robot;

FIG. 4 shows a state where an entry prohibited area and an entry restricted area are projected onto a floor surface;

FIG. 5A is a diagram for explaining a first illumination mode;

FIG. 5B is a diagram for explaining a first illumination mode;

FIG. 6A is a diagram for explaining a second illumination mode;

FIG. 6B is a diagram for explaining a second illumination mode;

FIG. 6C is a diagram for explaining a second illumination mode;

FIG. 7A is a diagram for explaining a third illumination mode;

FIG. 7B is a diagram for explaining a third illumination mode;

FIG. 7C is a diagram for explaining a third illumination mode;

FIG. 8A is a diagram for explaining a fourth illumination mode;

FIG. 8B is a diagram for explaining a fourth illumination mode;

FIG. 9A is a diagram for explaining a fifth illumination mode;

FIG. 9B is a diagram for explaining a fifth illumination mode; and

FIG. 10 shows a process flow for illumination.

### DESCRIPTION OF EMBODIMENTS

Hereinafter, the present disclosure will be explained through embodiments of the present disclosure. However, they are not intended to limit the scope of the present disclosure according to the claims. Further, all of the components/structures described in the embodiments are not necessarily indispensable as means for solving the problem.

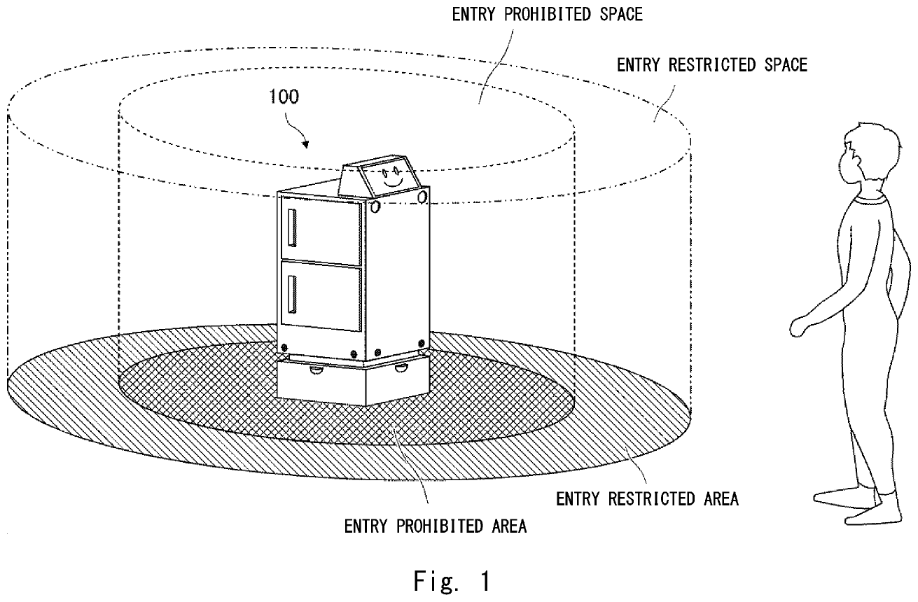

FIG. 1 shows a state where a transfer robot 100 according to this embodiment moves in an environment in which people coexist with the transfer robot. The transfer robot 100 is an example of an autonomous mobile body that moves autonomously. An autonomous mobile body system may include an autonomous mobile body and a server that supports the autonomous mobile body. However, a mobile body system described below is an example in which the autonomous mobile body system is solely constituted of the transfer robot 100. The transfer robot 100 moves autonomously and conveys a stored object to be conveyed (hereinafter also referred to as a conveyed object) to a determined destination. When the transfer robot 100 arrives at the determined destination, a person who is supposed to receive the conveyed object can collect the stored conveyed object.

The transfer robot 100 moves toward the destination while monitoring the surrounding environment and avoiding obstacles. It is assumed that the environment in which the transfer robot 100 is used in this embodiment is an environment in which people also come and go. The environment is not limited to indoor environments such as a hospital, an airport, a shopping mall, and a hotel, but also includes outdoor environments such as a theme park or a tourist resort. In such an environment where people also come and go, the transfer robot 100 needs to recognize a person who is moving closer to it as an obstacle and thereby avoid contact with the person by stopping its movement or performing an evasive action. Therefore, the transfer robot 100 is equipped with various sensors for detecting an obstacle, and the transfer robot 100 is controlled by a control program so that it operates according to the result of the detection.

Specifically, as shown in FIG. 1, an entry prohibited space is set around the transfer robot 100. When any one of the various sensors detects an obstacle that enters this entry prohibited space, the transfer robot 100 stops its movement. Further, an entry restricted space is set outside the entry prohibited space. When any one of the various sensors detects an obstacle that enters this entry restricted space, the transfer robot 100 reduces its moving speed or performs an evasive action for avoiding the obstacle.

In FIG. 1, these spaces are represented by a columnar space and a cylindrical space, respectively, around the transfer robot 100. The sizes and shapes of them are determined as appropriate according to the environment in which the transfer robot 100 is used, the size and the moving performance of the transfer robot 100, the detection ranges of the various sensors, and the like. The detecting ability of the transfer robot 100 for detecting an obstacle extends to the outside of the entry restricted space, and with which the transfer robot 100 can detect, for example, a person moving closer to the entry restricted space as shown in FIG. 1. Further, in this embodiment, a surface on which the transfer robot 100 moves is referred to as a moving surface (also referred to as a floor surface). Further, an area on the floor surface onto which the entry prohibited space is projected is defined as an entry prohibited area, and an area on the floor surface onto which the entry restricted space is projected is defined as an entry restricted area.

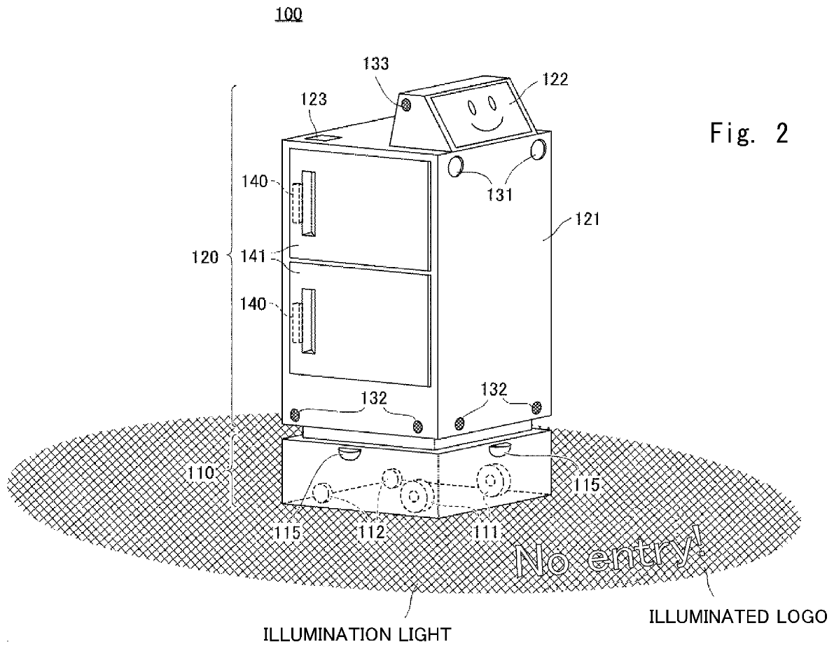

FIG. 2 is a perspective view of an external appearance of the transfer robot 100. In particular, FIG. 2 shows a state where illumination sub-units 115 illuminate a floor surface so as to indicate an entry prohibited area. The moving robot 100 includes, mainly, a movable base part 110 and a main-body part 120.

The movable base part 110 supports two driving wheels 111 and two casters 112, each of which is in contact with the floor surface, inside a rectangular cover. The two driving wheels 111 are arranged so that the centers of their rotation axes coincide with each other. Each of the driving wheels 111 is rotationally driven by a motor (not shown) independently of each other. Each of the casters 112 is a driven wheel and is disposed so that its pivotal axis extending from the movable base part 110 in the vertical direction axially supports the wheel at a place away from its rotation axis. Further, the casters 112 follow so as to move in the moving direction of the movable base part 110.

For example, when the two driving wheels 111 are rotated in the same direction at the same rotational speed, the transfer robot 100 moves straight. Further, when the two driving wheels 111 are rotated in the opposite directions at the same rotational speeds, the transfer robot 100 rotates around a vertical axis passing through substantially the center of the two driving wheels 111 of the movable base part 110. That is, the transfer robot 100 can move straight in an arbitrary direction and turn to an arbitrary direction by controlling the rotational direction and rotational speed of each of the two driving wheels 111.

An illumination sub-unit 115 with a small projector disposed therein is provided in each surface of the cover of the movable base part 110. Each of the illumination sub-units 115 can illuminate a certain area on the floor surface toward which that illumination sub-unit 115 is pointed. For example, as shown in FIG. 2, the four illumination sub-units 115 cooperate with each other and thereby can apply illumination light to the floor surface so that an entry prohibited area, which is defined as a circular area, can be visually recognized. Further, it is also possible to project an illuminated logo, i.e., projected text or a projected mark such as “No entry!” indicating that the circular area is the entry prohibited area. Details of specific illumination modes will be described later.

The main-body part 120 mainly includes a housing part 121 mounted above the movable base part 110, and a display panel 122 disposed in an upper-surface part of the housing part 121. The housing part 121 has a rectangular parallelepiped shape, and a rack for storing a conveyed object, a control box containing a control unit (which will be described later) and the like are housed inside the housing part 121. The rack for storing the conveyed object is disposed in a container part inside the housing part 121. Further, the rack is closed by a housing door 141 when the conveyed object is conveyed. When an ID card or a portable terminal storing an electronic unlocking key therein is brought close to a reading unit 123, an electronic lock 140 is unlocked and the housing door 141 is opened.

The display panel 122 is, for example, a liquid crystal panel. The display panel displays an illustration of a face of a mascot character and/or shows text and/or an icon indicating information about the transfer robot 100. It is possible, by displaying the face of the mascot character on the display panel 122, to give an impression as if the display panel 122 is a face part of the transfer robot 100 to nearby people observing the transfer robot 100. Further, the display panel 122 includes a touch panel on its display surface and can receive an instruction input by a user. Further, a speaker 133 is provided near the display panel 122. The speaker 133 can produce a sound or a voice for informing people around the transfer robot 100 of the state thereof or the like.

A stereo camera 131 is installed in an upper part of the housing part 121 below the display surface of the display panel 122. The stereo camera 131 has a configuration in which two camera units having the same angle of view are arranged apart from each other in the horizontal direction, and outputs images taken by the respective camera units as image data. In a lower part of the housing part 121, an ultrasonic sensor 132 oriented in the horizontal direction is installed on each of the housing surfaces. The transfer robot 100 recognizes an obstacle located around it and/or determines its own position by analyzing image data output from the stereo camera 131 and detection signals output from the ultrasonic sensors 132. As shown in FIGS. 1 and 2, the side of the transfer robot 100 on which the stereo camera 131 is disposed is defined as the front side thereof.

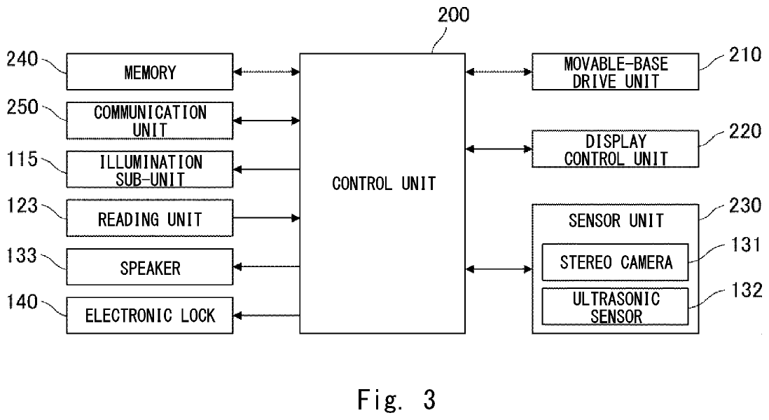

FIG. 3 is a control block diagram of the transfer robot 100. A control unit 200 is, for example, a CPU (Central Processing Unit), and performs overall control of the transfer robot 100 by executing a control program loaded from a memory 240. A movable-base drive unit 210 includes a drive circuit and a motor(s) for driving the driving wheels 111. The control unit 200 sends a drive signal to the movable-base drive unit 210 and thereby controls the driving of the driving wheels 111. That is, the control unit 200 cooperates with the movable-base drive unit 210 and thereby functions as a movement control unit that controls the movement of the transfer robot 100.

A display control unit 220 generates a display video image according to a control signal sent from the control unit 200, and displays the generated display video image on the display panel 122. Further, the display control unit 220 receives an operation performed on a touch panel disposed over the display panel 122, generates an operation signal based on the received operation, and transmits the generated operation signal to the control unit 200. A sensor unit 230 includes various sensors, and functions as a detection unit that detects people and objects present around the transfer robot 100. The stereo camera 131 and the ultrasonic sensor 132 are components included in the sensor unit 230. The control unit 200 drives the various sensors by sending control signals to the sensor unit 230, and acquires their output signals and output data.

The memory 240 is a nonvolatile storage medium. For example, a solid-state drive is used as the memory 240. The memory 240 stores various parameter values, functions, lookup tables, and the like used for the control in addition to the control program for controlling the transfer robot 100. In particular, the memory 240 stores an environment map in which map information of an environment in which the transfer robot 100 autonomously moves is described.

A communication unit 250 is, for example, a wireless LAN unit. The control unit 200 transmits/receives various types of information to/from a system server connected to an external network through the communication unit 250. For example, the control unit 200 acquires a latest environmental map and information about persons who are supposed to receive conveyed objects from the system server. Each of the illumination sub-units 115 includes a projector disposed therein as described above, and can illuminate the floor surface around the transfer robot 100. The control unit 200 can adjust the illuminated area on the floor surface by transmitting a control signal to the projector of each illumination sub-unit 115. Further, the illumination light by which the illuminated area is illuminated is not limited to monochromatic light. That is, it is also possible to show animation or the like of the above-described illuminated logo and/or the mascot character by incorporating a video signal into the control signal. Though its details will be described later, the control unit 200 cooperates with the illumination sub-units 115 and thereby functions as an illumination unit that illuminates the floor surface so as to indicate the entry prohibited area and/or the entry restricted area.

The reading unit 123 is a reading device for near-field communication for reading an electronic unlocking key stored in an ID card or a portable terminal therefrom when the ID card or the portable terminal is brought close to the reading device. The ID card or the portable terminal is equipped with, for example, a FeliCa (Registered Trademark) chip, and delivers the stored electronic unlocking key to the control unit 200 through the reading unit 123. When the acquired electronic unlocking key matches unlocking information of the electronic lock 140, the control unit 200 unlocks the electronic lock 140. The speaker 133 converts an audio signal sent from the control unit 200 into a sound or a voice, and thereby informs people around the transfer robot 100 of the state thereof or the like through the sound or the voice.

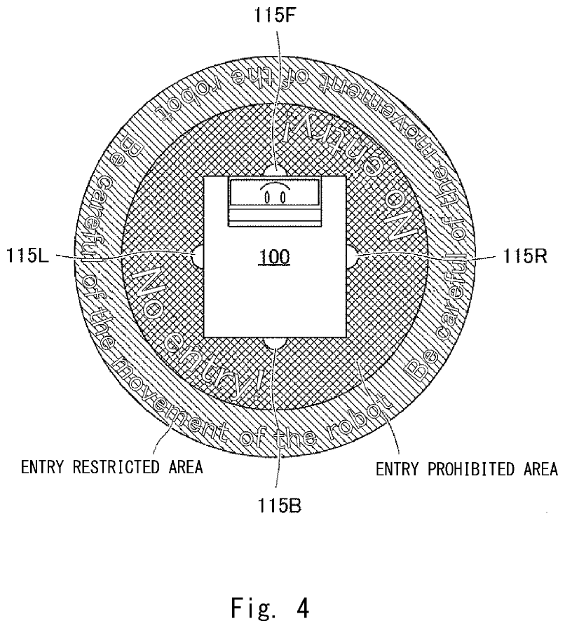

FIG. 4 shows a state where the illumination sub-units 115 illuminate the floor surface in such a manner that the entry prohibited area and the entry restricted area can be visually recognized. Specifically, FIG. 4 shows a state where the transfer robot 100 is viewed from above thereof. An illumination sub-unit 115F illuminates an area in front of the transfer robot 100 and an illumination sub-unit 115B illuminates an area behind thereof. Further, an illumination sub-unit 115R illuminates an area right to the transfer robot 100 and an illumination sub-unit 115L illuminates an area left thereto. The illuminated areas of the adjacent illumination sub-units 115 are partially overlapped with each other. The entry prohibited area illuminated on the floor surface is visually recognized as a continuous (i.e., seamless) circle (a double-hatched area in FIG. 4) and the entry restricted area is visually recognized as a continuous (i.e., seamless) doughnut shape (a single-hatched area in FIG. 4).

By seeing the illumination light by which the entry prohibited area is illuminated, a person who is present around the transfer robot 100 can make out that the transfer robot 100 will stop if he/she steps into the illuminated area. Even if the person does not have correct knowledge that the transfer robot 100 will stop, he/she may perceive that he/she may interfere with the movement of the transfer robot 100. Since it is desired that no person move closer to the transfer robot 100 during the movement thereof, the illumination sub-units 115 can also project an illuminated logo such as “No entry!” together with the illuminated area or change the color of the illumination light to a warning color such as yellow or red so that what the illuminated area means can be easily understood. By such illumination (or projection), a person who is present around the transfer robot 100 can easily make out how far he/she should be away from the transfer robot 100 so that he/she does not interfere with the movement thereof.

Further, by configuring the transfer robot 100 so that the entry restricted area is illuminated when a person around the transfer robot 100 steps into the entry restricted area, the person may regard the illumination as a warning from the transfer robot 100 and can immediately move away from the transfer robot 100. In this process, in order to make it easy to understand what the illuminated area means, the illumination sub-units 115 may also project an illuminated logo such as “Be careful of the movement of the robot” and/or may blink the illumination light.

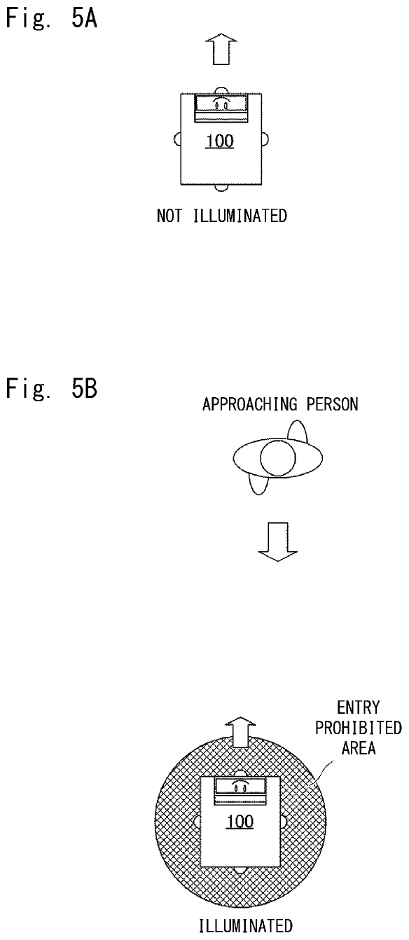

Next, several illumination modes in each of which the illumination sub-units 115 illuminate the floor surface will be described. FIGS. 5A and 5B are a diagram for explaining a first illumination mode. FIG. 5A shows a state where the detection unit has not detected a person who is moving closer to the entry prohibited space (hereinafter also referred to as an approaching person). At this point, the illumination unit does not illuminate the floor surface and the movement control unit moves the transfer robot 100 in the forward direction at a normal speed.

FIG. 5B shows a state where the detection unit has detected a person who is moving closer to the entry prohibited space. When the detection unit detects the approaching person, the illumination unit illuminates the entry prohibited area. By controlling the illumination as described above, it is possible to reduce the power consumption required for the illumination when there is no approaching person. Further, when an approaching person is detected, the person can be immediately urged to avoid the entry prohibited area.

Note that the case where the detection unit can recognize an approaching person as a human being has been described above. When the detection unit cannot distinguish between an approaching person and an approaching object, the detection unit may regard both of them as persons (i.e., as human beings). Further, the person moving closer to the entry prohibited space is not limited to those who are moving closer to the entry prohibited space from the front thereof. That is, even when a person is moving closer to the entry prohibited space from behind the entry prohibited space or from a side thereof, the illumination unit illuminates the entry prohibited area. Note that the illumination unit may illuminate the entry restricted area together with the entry prohibited area. Further, the detection unit determines whether or not a detected object is moving closer to the entry prohibited space based on the moving speed of the transfer robot 100 itself and a plurality of times of outputs of the sensor. Specifically, the detection unit determines whether or not the transfer robot 100 itself and the object have gotten relatively closer to each other by calculating distances to the object based on outputs of the sensor at different timings and comparing them with the moving distance that the transfer robot 100 has moved during the period between the different timings.

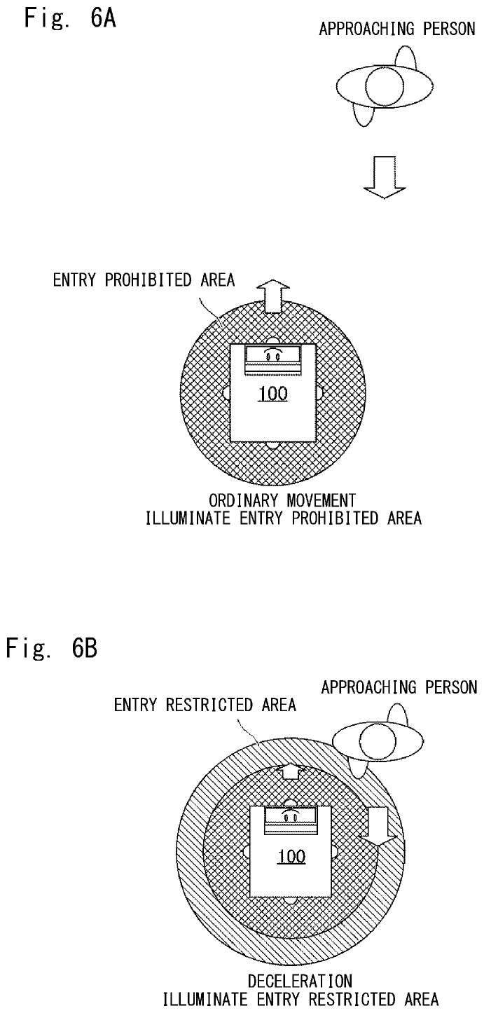

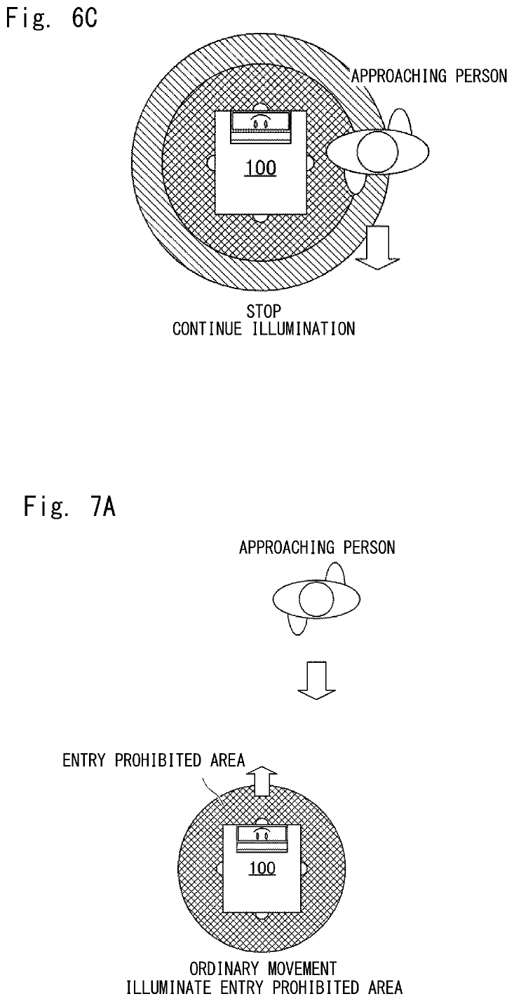

FIGS. 6A, 6B and 6C are a diagram for explaining a second illumination mode. FIG. 6A shows a state where the transfer robot 100 is moving in a normal state. In the example shown in FIGS. 5A and 5B, when the detection unit detects an approaching person, the illumination unit illuminates the entry prohibited area. In contrast, in the second illumination mode, the illumination unit illuminates the entry prohibited area during the movement of the transfer robot 100 irrespective of the result of the detection by the detection unit. By continuously illuminating the entry prohibited area as described above, even when there is an approaching person outside the detection range of the detection unit, the approaching person can visually recognize the illumination immediately and take action to avoid the transfer robot 100.

FIG. 6B shows a state where an approaching person has entered the entry restricted space. When the detection unit detects that an approaching person has entered the entry restricted space, the illumination unit illuminates the entry restricted area and the movement control unit reduces the moving speed of the transfer robot 100. If the approaching person becomes aware of the illumination of the entry restricted area or the illumination of the entry prohibited area at this stage and hence moves away from the transfer robot 100, the transfer robot 100 can return to the state shown in FIG. 6A. Note that when an approaching person has entered the entry restricted space, the illumination of the entry prohibited area may be stopped in order to make the illumination of the entry restricted area more conspicuous.

FIG. 6C shows a state where the approaching person shown in FIG. 6B has also entered the entry prohibited space. When the detection unit detects that the approaching person has entered the entry prohibited space, the illumination unit continues the illumination of the entry restricted area and that of the entry prohibited area, and the movement control unit stops the movement of the transfer robot 100. The transfer robot 100 waits until the approaching person moves out from the entry restricted space, and resumes its movement when the approaching person moves out therefrom. Note that even when the approaching person does not perceive the presence of the transfer robot 100 and comes into contact with the transfer robot 100, the impact can be minimized because the transfer robot 100 is already stopped.

The control unit 200 may produce a warning sound from the speaker 133 in the cases of FIGS. 6B and 6C. In this case, the control unit 200 cooperates with the speaker 133 and thereby functions as a warning unit. By producing the warning sound as described above, it is possible to prevent an approaching person from coming into contact with the transfer robot 100 as much as possible.

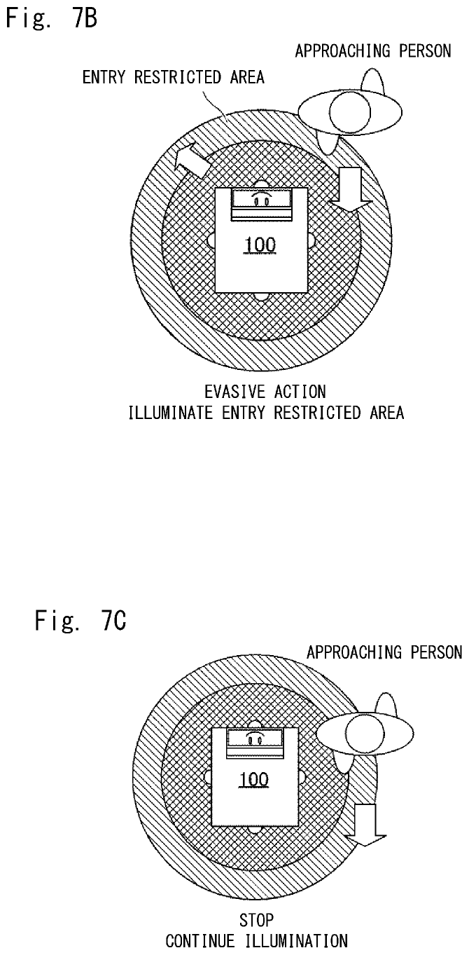

FIGS. 7A, 7B and 7C are a diagram for explaining a third illumination mode. FIG. 7A shows a state where the transfer robot 100 is moving normally as in the case of FIG. 6A. Further, FIG. 7C shows a state where an approaching person has entered the entry prohibited space as in the case of FIG. 6C. The behavior that is performed when an approaching person has entered the entry restricted space in the third illumination mode differs from that in the second illumination mode. FIG. 7B shows a state where an approaching person has entered the entry restricted space. When the detection unit detects that the approaching person has entered the entry restricted space, the illumination unit illuminates the entry restricted area and the movement control unit performs an evasive action for moving the transfer robot 100 away from the approaching person. It is possible to actively move the entry restricted space away from the approaching person by performing the evasive action, so that the transfer robot 100 can return to the normal moving state shown in FIG. 7A as soon as possible.

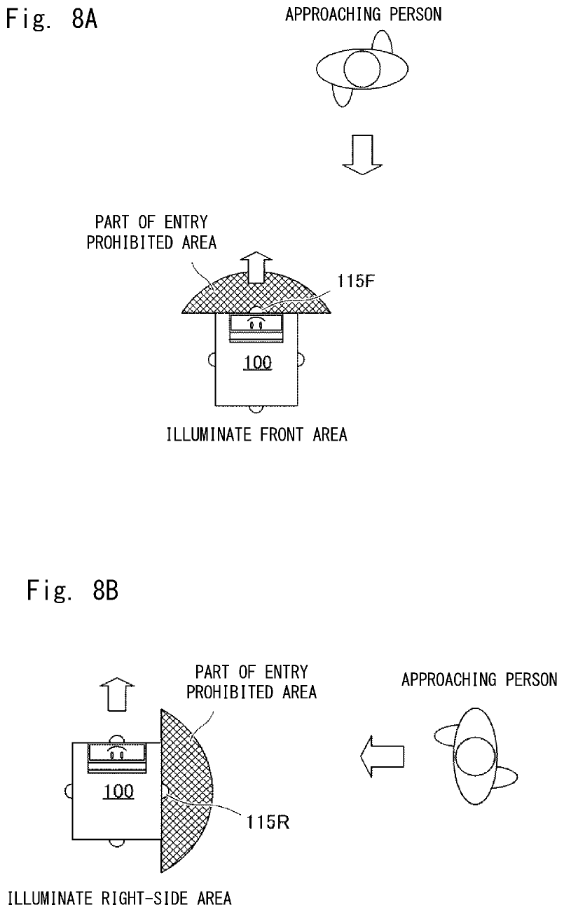

FIGS. 8A and 8B are a diagram for explaining a fourth illumination mode. In this embodiment, an illumination sub-unit 115 is provided on each of the surfaces of the cover of the movable base part 110. Therefore, the illumination unit can selectively illuminate the illumination sub-units 115. Therefore, in the fourth illumination mode, the illumination unit changes an illumination pattern projected on the floor surface according to the situation in which the detection unit detects an approaching person.

FIG. 8A shows a state where the detection unit detects an approaching person who is moving closer to the entry prohibited space from the front thereof. When the detection unit detects such an approaching person, the control unit 200 sends a control signal to the front illumination sub-unit 115F and thereby selectively illuminates a front part of the entry prohibited area. FIG. 8B shows a state where the detection unit detects an approaching person who is moving closer to the entry prohibited space from the right thereto. When the detection unit detects such an approaching person, the control unit 200 sends a control signal to the right-side illumination sub-unit 115R and thereby selectively illuminates a right-side part of the entry prohibited area. Similarly, when the detection unit detects an approaching person approaching from behind the transfer robot 100, the control unit 200 selectively illuminates the rear thereof. Further, when the detection unit detects an approaching person approaching from the left side, the control unit 200 selectively illuminates the left side. For example, when the detection unit detects an approaching person approaching from the front and that approaching from the rear at the same time, the control unit 200 illuminates the front and the rear.

By selectively illuminating a part of the entry prohibited area according to the direction in which the approaching person is detected, the power consumption can be reduced. Note that in the case where the entry restricted area is illuminated before an approaching person actually enters the entry restricted space, a part of the entry restricted area may be selectively illuminated according to the direction in which the approaching person is detected as in the case of the above-described example. Further, in addition to illuminating a part of the illuminated area, the illumination unit may change the illumination pattern according to the situation in which the detection unit detects the approaching person. For example, while illuminating the entire illumination area, an illuminated logo may be projected onto an area close to the approaching person, or the color of the illumination light may be changed to a conspicuous color.

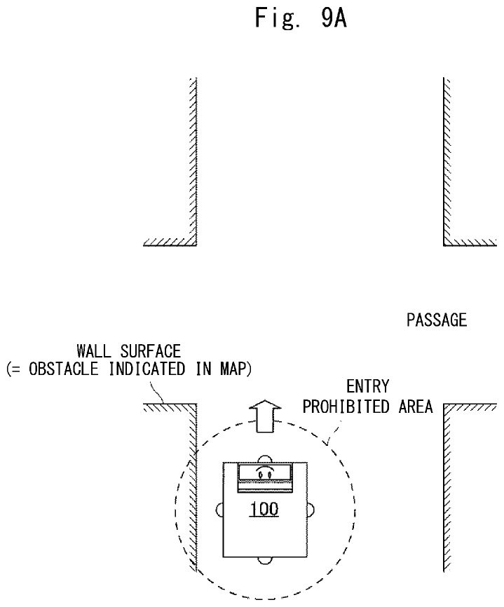

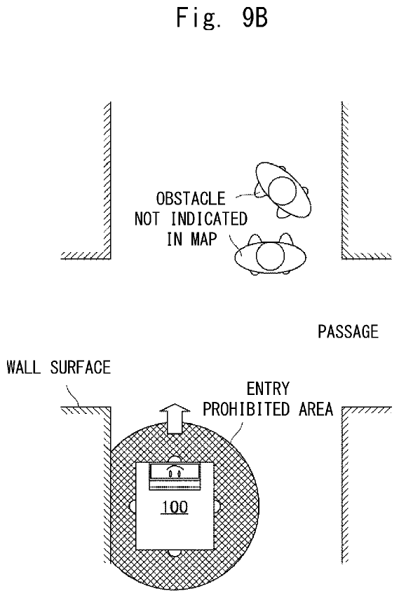

FIGS. 9A and 9B are a diagram for explaining a fifth illumination mode. In the four illumination modes described above, the illumination is controlled while regarding an approaching obstacle (i.e., an obstacle that is relatively getting closer to the robot) detected by the detection unit as an approaching person. However, there are cases where a stationary obstacle detected by the detector is a person who is standing and taking in the passage. It is desired that such a person also avoid the transfer robot 100 as appropriate so as not to interfere with the movement thereof. However, in most cases, a stationary obstacle detected by the detection unit is a structure in the environment. Therefore, the illumination unit performs illumination control according to the fifth illumination mode described below.

FIG. 9A shows a movement of the transfer robot 100 in a state where the detection unit does not detect any obstacle other than the structures indicated in the environmental map. For example, as shown in FIG. 9A, when only the wall surfaces indicated in the environmental map have been detected as obstacles by the detection unit, the illumination unit does not illuminate the entry prohibited area. That is, when the obstacles detected by the detection unit are the same as those indicated in the environmental map, the illumination on the floor surface is not performed and the power consumption is thereby reduced.

FIG. 9B shows a movement of the transfer robot 100 when the detection unit has detected an obstacle that is not indicated in the environmental map in the traveling direction. As shown in FIG. 9B, when the detection unit detects an obstacle in a place that is recognized (i.e., indicated) as a passage in the environmental map, the illumination unit illuminates the entry prohibited area. That is, when the detection unit detects an obstacle that is not indicated in the environmental map in the traveling direction, the detection unit illuminates the entry prohibited area and thereby calls attention to the obstacle. It is convenient for the transfer robot 100 if the obstacle that is not indicated in the environmental map is a person and takes an action for avoiding the illuminated area. If the obstacle that is not indicated in the environmental map does not or cannot take an action for avoiding the illuminated area, the transfer robot 100 performs an evasive action for avoiding the obstacle or stops its movement. Note that when the detection unit detects an obstacle that is not indicated in the environmental map, the illumination unit may illuminate the entry restricted area as well as the entry prohibited area.

The five illumination modes have been described above, and the transfer robot 100 may also perform two or more of these illumination modes in combination. In particular, by combining the fifth illumination mode, in which the environmental map is referred to, with the first to fourth illumination modes, it is possible to appropriately cope with both an approaching obstacle and a stationary obstacle.

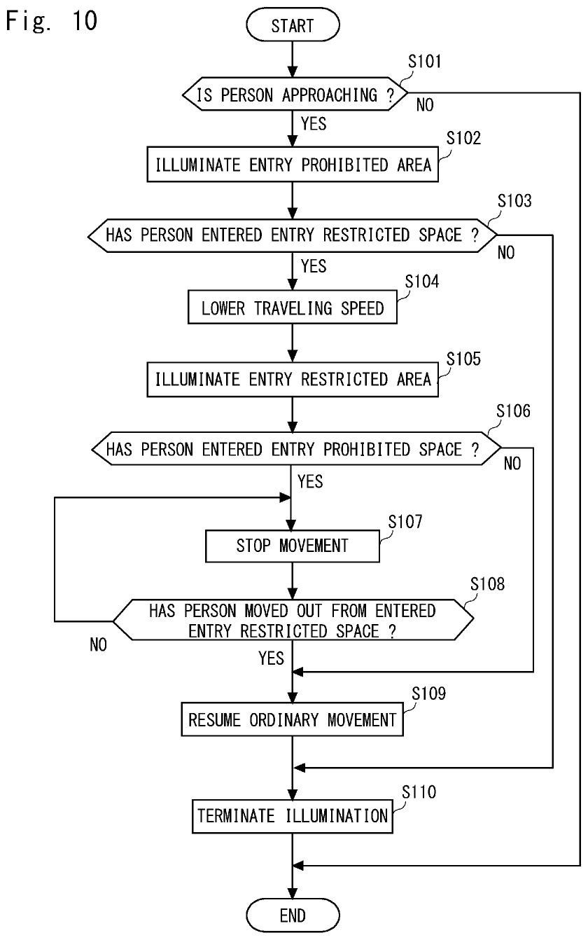

Next, a series of processes for illumination on the floor surface that is performed during the movement of the transfer robot 100 will be described. FIG. 10 shows a process flow for illumination. The flow shown in FIG. 10 is a typical example of a series of processes. That is, the flow shown in FIG. 10 does not cover all of the above-described illumination modes. The flow shown in FIG. 10 corresponds to a series of processes that is repeated during a period from when conveyance is started to when the transfer robot arrives at the destination or to when the conveyance is terminated.

When the transfer robot 100 is moving, the detection unit determines whether or not there is an approaching person who is moving closer to the entry prohibited space in a step S101. When there is no approaching person, the rest of the series of processes are skipped and the process is finished. When the detection unit detects an approaching person, the process proceeds to a step S102 and the illumination unit illuminates the entry prohibited area. The detection unit continues detecting the approaching person and determines whether or not the approaching person has entered the entry restricted space (step S103). When the approaching person moves away from the entry restricted space without entering that space, the process proceeds to a step S110. When the approaching person has entered the entry restricted space, the process proceeds to a step S104.

In a step S104, the movement control unit lowers the moving speed of the transfer robot 100. Then, in a step S105, the illumination unit illuminates the entry restricted area. The process proceeds to a step S106 and the detection unit determines whether or not the approaching person has entered the entry prohibited space. When the approaching person moves away from the entry prohibited space without entering that space, the process proceeds to a step S109. When the approaching person has entered the entry prohibited space, the process proceeds to a step S107.

In a step S107, the movement control unit stops the movement of the transfer robot 100. The detection unit continues detecting the approaching person and determines whether or not the approaching person has moved out from the entry restricted space (step S108). When the approaching person has not moved out from the entry restricted space, the process returns to the step S107 and the movement control unit maintains the transfer robot 100 in the stopped state. When the approaching person has moved out from the entry restricted space, the process proceeds to a step S109 and the movement control unit resumes the normal movement at the normal speed. In a step S110, the illumination unit terminates the illumination on the floor surface, which has been continued until then. When the process returns to the normal movement control, the series of processes is finished.

In this embodiment described above, the transfer robot 100 has been described as an example of an autonomous mobile body. However, the autonomous mobile body is not limited to the transfer robot. That is, the illumination control described in the above-described embodiment can be performed as long as the autonomous mobile body is one that autonomously moves in an environment in which people and the mobile body coexist. Further, although the transfer robot 100 is equipped with the four illumination sub-units 115 disposed on the cover of the movable base part 110, the configuration of the illumination unit is not limited to such a configuration. For example, when the housing of the movable base part or that of the main-body part has a cylindrical shape, a configuration in which illumination sub-units are arranged in a ring configuration so as to surround the housing may be adopted. Further, although the projector is used in this embodiment so that an illuminated logo or animation can be projected, an illumination unit having a simple configuration such as LED illumination may also be adopted as long as the illumination unit has an illuminating function for illuminating a floor surface.

Further, the autonomous mobile body system is not limited to the case where it is constructed by the autonomous mobile body alone. That is, the autonomous mobile body system may be constructed in such a manner that the functions thereof are distributed over the autonomous mobile body, and a server and other apparatuses. For example, the detection unit that detects an obstacle around the autonomous mobile body may include a camera that is provided, for example, on the ceiling of a facility in which the autonomous mobile body moves. Images output from the camera are sent to the server and the server can determine whether or not an obstacle is present around the autonomous mobile body. Further, it is also possible to adopt a configuration in which the server is substantially in charge of the movement control of the autonomous movement, and performs control so as to stop the movement of the autonomous mobile body when the server detects an obstacle that enters the entry prohibited space.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An autonomous mobile body system comprising an autonomous mobile body configured to move autonomously, further comprising:
a detection unit configured to detect an obstacle around the autonomous mobile body;
a movement control unit configured to stop a movement of the autonomous mobile body when the detection unit detects an obstacle that enters an entry prohibited space set around the autonomous mobile body; and
an illumination unit configured to illuminate a moving surface so as to indicate an entry prohibited area, the moving surface being a surface on which the autonomous mobile body moves, and the entry prohibited area being an area on the moving surface onto which at least a part of the entry prohibited space is projected.

2. The autonomous mobile body system according to claim 1, wherein when the detection unit detects an obstacle that enters an entry restricted space larger than the entry prohibited space, the movement control unit reduces a moving speed of the autonomous mobile body, and the illumination unit illuminates the moving surface so as to indicate an entry restricted area on the moving surface in addition to or instead of illuminating the entry prohibited area, the entry restricted area being an area on the moving surface onto which at least a part of the entry restricted space is projected.

3. The autonomous mobile body system according to claim 1, wherein the illumination unit illuminates the moving surface when the detection unit detects a person who is moving closer to the entry prohibited space.

4. The autonomous mobile body system according to claim 1, wherein the illumination unit illuminates the moving surface when the detection unit detects an obstacle that is not indicated in an environmental map that the movement control unit refers to.

5. The autonomous mobile body system according to claim 1, wherein the illumination unit changes an illumination pattern projected on the moving surface according to a situation in which the detection unit detects an obstacle.

6. The autonomous mobile body system according to claim 1, further comprising a warning unit configured to produce a warning sound when the detection unit detects that a person has entered an area illuminated by the illumination unit.

7. A non-transitory computer readable medium storing a control program for an autonomous mobile body configured to move autonomously, for causing a computer to perform:
a detection step of detecting an obstacle around the autonomous mobile body;
a movement control step of stopping a movement of the autonomous mobile body when an obstacle that enters an entry prohibited space set around the autonomous mobile body is detected in the detection step; and
an illumination step of illuminating, when at least an obstacle is detected in the detection step, a moving surface so as to indicate an entry prohibited area, the moving surface being a surface on which the autonomous mobile body moves, and the entry prohibited area being an area on the moving surface onto which at least a part of the entry prohibited space is projected.

8. A method for controlling an autonomous mobile body configured to move autonomously, comprising:
a detection step of detecting an obstacle around the autonomous mobile body;
a movement control step of stopping a movement of the autonomous mobile body when an obstacle that enters an entry prohibited space set around the autonomous mobile body is detected in the detection step; and
an illumination step of illuminating, when at least an obstacle is detected in the detection step, a moving surface so as to indicate an entry prohibited area, the moving surface being a surface on which the autonomous mobile body moves, and the entry prohibited area being an area on the moving surface onto which at least a part of the entry prohibited space is projected.
